(19) United States
(12) Patent Application Publication
(10) Pub. No.: US 2003/0060249 A1
(43) Pub. Date: Mar. 27, 2003

(54) Electronic amusement game

(76) Inventor: Jack Guarnieri, Jackson, NJ (US)

Correspondence Address: Richard C. Woodbridge, Woodbridge & Associates, P.C., P.O. Box 592, Princeton, NJ, 08542, US

(21) Appl. No.: 10/255,321

(22) Filed: Sep. 26, 2002

Related U.S. Application Data
(60) Provisional application No. 60/324,859, filed on Sep. 26, 2001.

(51) Int. Cl. A63F 13/00

(52) U.S. Cl. 463/2

(57) ABSTRACT

A game apparatus having a lane surface and electronic scoring that incorporates a variety of electronic features such as a video monitor display and interconnections with other games and/or external databases. These features permit conducting of competitions with distant games, the displaying of advertising on the game's display device, and upgrading of a particular game via downloaded software. The game apparatus also features a “Mulligan” or “do-over” option which allows a player to void an unsatisfactory turn and thereby permits him to redo this turn.

### BACKGROUND OF THE INVENTION

During the 1950's Bowling was a big American past time. Coin-operated games were created to simulate the action of bowling in a different venue than a bowling alley and were typically located at an amusement arcade or local tavern or bar.

There were basically two types of coin-op bowling games. A “Ball Bowler” which used a ball that the player rolled down a long (12′ to 14′) alley and struck pins. The ball was returned to the player and the pins were reset by the game. It was bowling on a smaller scale.

The other type of game became known as “Shuffle Alley” or “Puck Bowling”. These alleys were typically eight to ten feet long. A metal “hockey puck” was used by the player and slid or shuffled down the alley toward the bowling pins. The puck slid over switches on the alley which corresponded to pins that retracted upward and scored points.

The puck was rebounded back to the player after each shot by bouncing off of rubber bumpers behind and on each side of the pins.

The games were built in a dedicated format and theme. If the game was built with a bowling or other sports theme it could not be changed. Coins were inserted for the number of players. For example, it may cost ten cents per player per game. The game could be played by one to six players in rotation.

The game was built and used as an amusement game and typically not as a linked or redemption type of game.

### SUMMARY OF THE INVENTION

The present invention incorporates the use of a puck to be called a “Jack”. In one embodiment of the invention the player slides the Jack down an alley towards a set of bowling pins. These pins are suspended above the alley surface in a mechanical pin setting mechanism in the traditional configuration of ten pin bowling.

This bowling embodiment relates to a game that combines the fun of bowling with modern technology. In various additional embodiments of the invention a modem, CD-ROM, wired or wireless technology, or combinations thereof, are used to permit linking between a plurality of games. Thus, for example tournament and non-tournament play between two or more games can communicate with each other so that team and tournament play can be enabled between two or more game units.

In a further embodiment of the invention a video monitor is used for various display functions of the invention. In yet a further embodiment of the invention, advertising is capable of being displayed on the game's display thereby providing additional revenue sources.

In an additional embodiment of the invention a modem or CD drive will enable software to be upgraded for different versions, game titles and themes.

### DESCRIPTION OF THE DRAWINGS

FIG. 1 depicts the apparatus of one embodiment of the invention.

FIG. 2 is a flow chart indicating various game functions of one embodiment of the invention.

### DETAILED DESCRIPTION OF THE INVENTION

In one embodiment of the invention, a player inserts money by coin, bill, debit card, etc. prior to commencement of the game. He then selects the number of players as well as what type of game will be played.

The player then has the option of entering his name or initials into the game or settling for the system default assignment of “Player 1”, “Player 2”, etc. Operator controls, included in the program of the game, may limit a player's choice of names to a maximum number of letters or prohibit profane words or names.

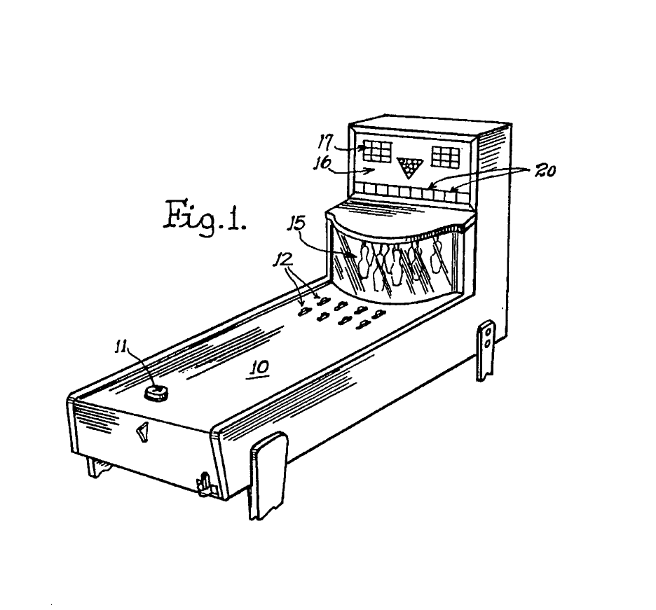

Referencing the embodiment depicted in FIG. 1 various display areas, labeled 17 and 20, are located on a rear panel 16 which faces the player. Alternative embodiments permit the use of a single video monitor to display not only player and score information but additional features as well. These features include various messages to the players, to include commercial advertisements.

Again referencing the embodiment depicted in FIG. 1, in the actual play of the game, the player takes the Jack (puck) 11 and slides it down an alley 10 towards the pins 15. The Jack passes over switches (mechanical, electronic or magnetic) in the alley 12. In one embodiment of the game activation of these switches corresponds to the bowling pins “knocked down” by his Jack. These scored pins are then retracted upward into the mechanism leaving the pins in place which were not hit or activated by the Jack. The player then has a second shot to complete his frame. The game progresses along using the rules of the game. These rules can be displayed on the display device either automatically or in response to a player inquiry.

In a further embodiment, the Jack can also be designed as a wireless transmitter. The transmitter will trigger different features and functions as it passes down the alley. For example, different lighting effects on the alley surface or adjacent to the alley surface. It could also trigger electromagnets under the alley surface to effect the way the Jack travels. It may slow down, speed up or move to the left or right. These features can be either player or operator selectable options that are used in different choices for games played.

In an additional embodiment of the invention the wireless Jack, by using a. switched setting, can be programmed to work only with a unique game wireless receiver. Therefore, if desired by operator setting, no other Jack would work on a particular game machine. This would help eliminate the possibility of cheating in tournament mode of operation.

In a further embodiment, the invention is designed to be redemption type of game. That is, a game that will employ a ticket dispenser to reward players with redemption tickets that will be redeemed in exchange for prizes.

In a further embodiment of the invention, a player has a choice during game play that is similar to a “Mulligan” in Golf. If a player is dissatisfied with the outcome of his latest turn, he can elect to take than turn over again. Simply by inserting more money or deducting an appropriate number of game credits, the player can “do over” his last turn. The use of this feature may be limited by the system to perhaps, as many as two times per game.

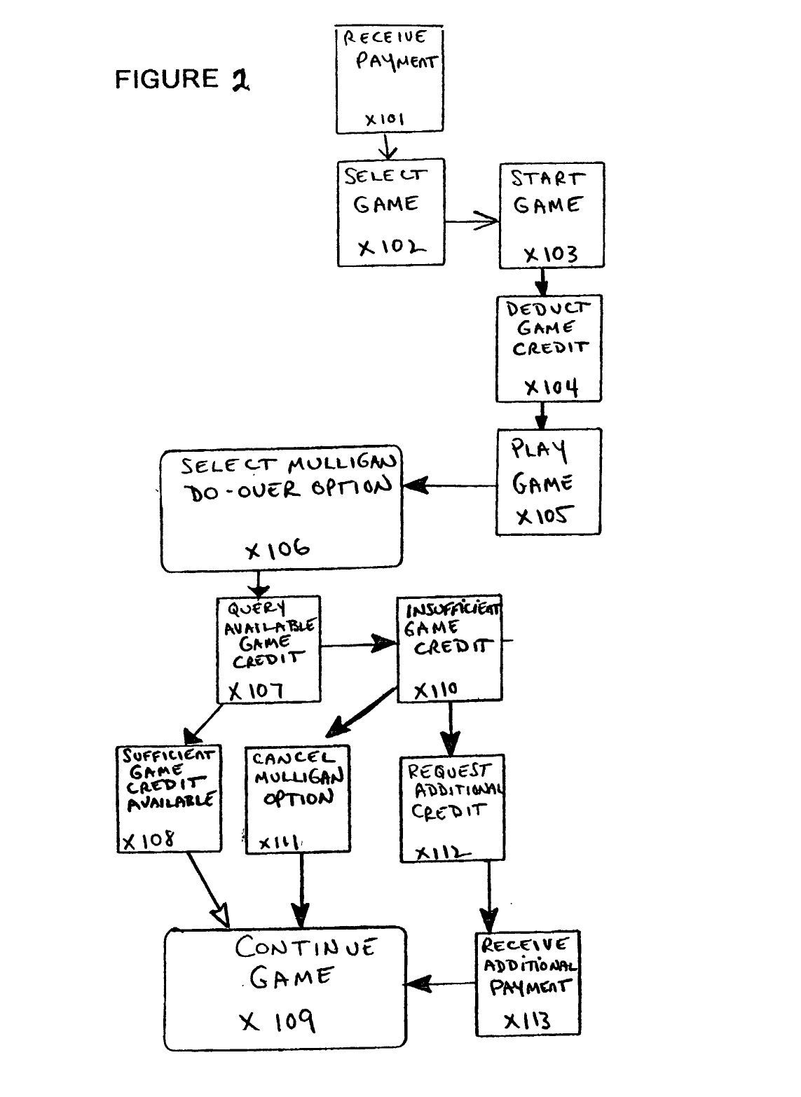

FIG. 2 is a flowchart which depicts various functions of one embodiment of the invention. In particular, it shows the process by which the game receives payments, a game is selected and then started, game credits are deducted and a game is played. It further shows the “Mulligan Do Over” game option feature.

As illustrated in FIG. 2 a payment receiving means 101 accepts payment by a player. Payment can be in the form of deposited coins, bills, debit or credit cards. Accordingly, the payment receiving means 101 includes, but is not limited to, a coin slot, bill acceptor or swipe card reader and associated circuitry for discerning the amount of money or game credit received. Each game credit may represent a fixed sum of money. For example a quarter dollar may represent one game credit. The current number of game credits available to the player is displayed on a display device.

A game selection means 101 is then activated by the player. By way of example, the player would press a simple button to select which game he wants to play. The player would then press a start game button 103 to begin play. As the game is activated, the system would deduct an appropriate number of credits from the total game credits available and display the new total.

Item 105 of FIG. 2 illustrates the player actually playing the game. While playing, the player has the option to use a “Mulligan Do Over” at additional cost to repeat a game segment and try to get a better score. Thus, for example, a “Mulligan Do Over” button 106 can be pressed by the player to activate this feature. Once the “Mulligan Do Over” option is so requested, the system determines if sufficient game credits are available to the player 107 to honor this request. If sufficient credits are available 108, the process continues to step 109 and play continues with the “Mulligan Do Over” feature permitting replay of the segment.

Should sufficient game credits not be available, as indicated by step 110, the system displays a message 112 to the player that “Additional Credit needed”. The player, by not inserting the additional payment within a specified time limit, thereby causes the action in step 111 and the “Mulligan Do Over” option is canceled. Alternatively, the player, by inserting additional payment 113 within a specified time limit, permits the “Mulligan Do Over” request to be honored and the process then continues to step 109 where game play continues.

It is envisioned that the present invention can be implemented in various different embodiments. For example various alternative physical models are contemplated. The commercial model will be the longest, up to 15 feet long. A home model will be shorter in length, perhaps eight to ten feet long and a children's version perhaps six to eight feet long. Each of these models can be built as a single or double alley game. The game can be played as an individual unit as a single stand-alone game. The single model will have features that will enable it to be linkable between units by electronic wiring or wireless technology.

The link feature will enable two or more units to communicate with each other so that team and tournament play can be enabled between units and players.

In a further, double game embodiment, two alleys built and sold as one game will be linkable by electronic wiring, switch or program setting.

Embodiments of the invention which permit linking of games permit competition of players at separate locations. It further enables bonus redemption ticket jackpots. The latter is possible using existing well known technology. In such embodiments, the above Mulligan Do Over feature may be disabled or limited in various respects in accordance with the program options set in compliance with the rules of the competition.

In one embodiment of the invention a web site may be used to track players, linked games, tournament play, scoring, promotions, advertising, service bulletins, sales, marketing and other information. Players who register with the web site will have their scores and averages tracked and will have access to that information by computer as well as every time they play a linked game.

In a further embodiment of the invention, a modem is utilized so that games could be linked in tournaments and players from linked games are able to compete against each other for prizes. The modem also enables the game to be updated for different version software and theme. By downloading software onto the Central Processing Unit (CPU) of the game's hardware, the program of the game is readily changed. Incorporating that with a physical change in the artwork or translite on the game cabinet, the game is thereby converted from one program and theme to another.

In a further embodiment of the invention, updated program chips or a CD-ROM will be available for purchase to upgrade the game version, program and title. Some game upgrades may include replacement of the bowling pins for a different theme or the entire pin setting mechanism.

In a further embodiment of the invention the modem would enable advertising to be downloaded to the game to be displayed between frames or at timed intervals when the game is not being played. Alternatively, in the event a modem is not used, a plug-in chip containing advertising could be inserted into the CPU.

It is to be understood that the foregoing disclosure taught and described herein is illustrative of the present invention. Modifications may readily be devised by those ordinarily skilled in the art without departing from the spirit or scope of the present invention.

We claim:

1. A game apparatus having electronically controlled scoring means comprising:
a Jack for sliding movement by a player to thereby actuate the scoring means;
a platform forming an alley having a player end and a scoring end, said alley having a plurality of electrical switches, each having actuating means, said actuating means being mounted with relation to said platform for actuation by movement of said Jack along said alley; and
an electronic display means;

2. The game apparatus of claim 1 further comprising a payment receiving means.

3. The game apparatus of claim 2 wherein a score is derived for each event of sliding the Jack down the alley by a player, said apparatus further comprising a Mulligan means for voiding that score and thereby permitting the player to redo at least one said event.

4. The game apparatus of claim 3 wherein said Mulligan means further comprises a means for imposing a financial cost to the player.

5. The game apparatus of claim 4 wherein said Mulligan means further comprises a means for not permitting said voiding to occur unless the player satisfactorily meets the financial cost.

6. The game apparatus of claim 1 wherein said Jack further comprises a wireless transmitter means.

7. The game apparatus of claim 6 wherein said wireless transmitter means further comprises a means for triggering game features.

8. The game apparatus of claim 6 further comprising a wireless receiver, said receiver associated with a unique Jack, wherein said scoring means is actuated only with the sliding movement of said unique Jack.

9. The game apparatus of claim 1 further comprising a linking means.

10. The game apparatus of claim 9 wherein said linking means is a modem.

11. The game apparatus of claim 9 wherein said linking means enables connection of the game apparatus with a web site.

12. The game apparatus of claim 9 wherein said linking means enables connection of the game apparatus with another similar game apparatus.

13. The game apparatus of claim 1 wherein the scoring means comprises a software program and said game apparatus further comprises a game update means.

14. The game apparatus of claim 13 wherein said game update means comprises a means for installing software upgrades.

15. The game apparatus of claim 14 wherein said means for installing software upgrades comprises use of a modem.

16. The game apparatus of claim 14 wherein said means for installing software upgrades comprises use of a CD-ROM.

17. The game apparatus of claim 13 wherein said game update means comprises installation of updated program chips.

18. The game apparatus of claim 9 wherein said linking means further comprises an advertising means for obtaining advertising information and displaying said advertising information on the display means.

19. The game apparatus of claim 1 further comprising a rewarding means for rewarding players.

20. The game apparatus of claim 1 wherein the electronic display means comprises a video monitor.

21. An improved method for conducting a game having a Jack for sliding down a game alley and an electronically controlled scoring means, said method comprising the steps of:
displaying on a video monitor messages to the player; and,
interconnecting the game to an external location to thereby permit exchange of information with said external location.

22. The method of claim 21 wherein said messages comprise video advertisements.

23. The method of claim 21 wherein said exchange of information comprises software upgrades to the game.

24. The method of claim 21 wherein said exchange of information comprises scoring information.
